(19) United States
(12) Patent Application Publication
(10) Pub. No.: US 2006/0038739 A1
(43) Pub. Date: Feb. 23, 2006

(54) Spiral cylindrical ceramic circular polarized antenna

(76) Inventors: I-Peng Feng, Hsinchu City (TW); Hsin-Ho Ko, Hsinchu City (TW)

Correspondence Address: Keith Kline;PRO-TECHTOR INTERNATIONAL SERVICES, 20775 Norada Court, Saratoga, CA, 95070-3018, US

(21) Appl. No.: 10/923,907

(22) Filed: Aug. 21, 2004

(51) Int. Cl. H01Q 1/36

(52) U.S. Cl. 343/895

(57) ABSTRACT

A spiral cylindrical ceramic circular polarized antenna, wherein a cylindrical ceramic body is made of microwave ceramic material with the dielectric constant equal to or greater than 20, and spiral radiation metallic electrodes are printed on the ceramic body to cause 90 degrees of phase difference between the neighboring spiral radiation metallic electrodes. A BALUN and transformer component, PCB, or ceramic ground plane is configured on the bottom tie-plate of the ceramic body to transfer the feed signal from unbalanced signal to balanced signal and to offer a matching impedance. With this design, two mutually perpendicular electromagnetic fields are formed to create CPW (Circular Polarized Wave), in order to facilitate the reception of GPS satellite signal.

### BACKGROUND OF THE INVENTION

a) Field of the Invention The present invention relates to an antenna, and more particularly to a GPS (Global Positioning System) antenna that minimizes the volume of the antenna set and the influence of ambient environment to the radiation pattern of the antenna, and that is omni antenna such that signal can be received at any position when the antenna is integrated with PDA (Personal Digital Assistant), cellular phones, or GPS hand-held devices.

b) Description of the Prior Art

Most of the energy emitted and received by radio wave for conventional microwave antenna hand-held electronic devices or other communication products will be affected by hand, head, or body of a user, and the near-field energy is huge by the antenna, thereby wasting most of the radiation energy and causing the efficiency and response of the antenna to be worse than expected. Moreover, the conventional antenna must use metal for grounding, and its radiation pattern has specific direction, such as that general hand-held electronic devices must align the antenna to the sky to be able to receive signal.

Accordingly, these shortcomings need to be fixed, and a new GPS antenna is invented.

### SUMMARY OF THE INVENTION

The present invention is a GPS antenna comprising a body made of microwave ceramic material, and spiral radiation metallic electrodes to form a rotation loop structure that can reduce induction noise and serve as a better wave filter, and with right circular polarized all direction radiation pattern, and ceramic ground plane that including balun and transformer component. This GPS antenna has a complete 360 degrees of reception capability, and thereby when integrating with PDA, cellular phones, or GPS hand-held devices, signal can be received independent of their positions; whereas conventional antenna requires horizontal position to be able to receive signal.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a top view of the present invention.

FIG. 2 shows a side view of the present invention.

FIG. 3 shows the influence of antenna by loading status for S11 of the present invention.

FIG. 4 shows an implementation of the present invention.

### DETAILED DESCRIPTION OF THE PREFERRED EMBODIMENTS

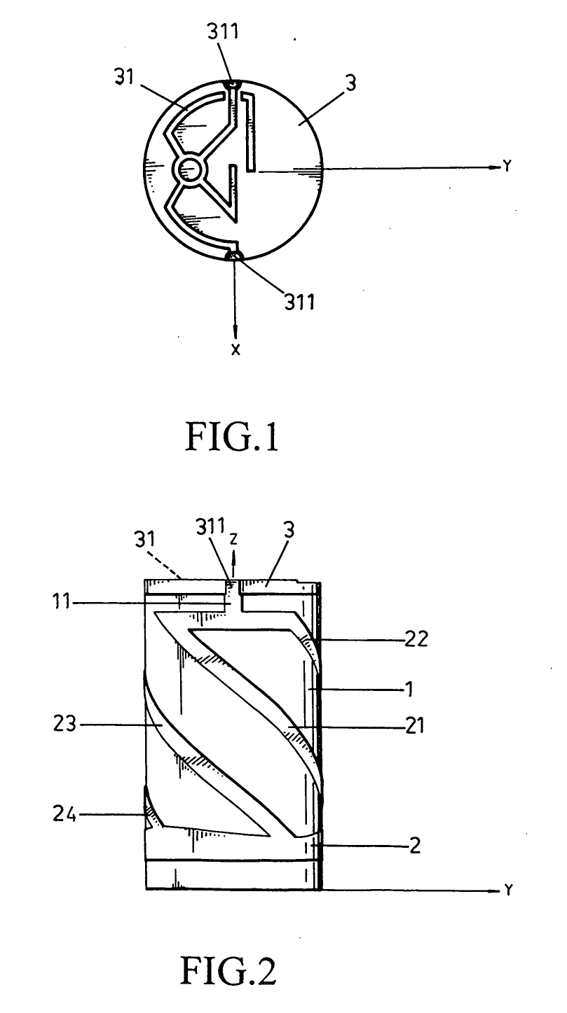

Referring to FIG. 1 and FIG. 2, the present invention comprises a cylindrical ceramic body 1, a metallic ring 2, and a ceramic ground plane 3 or PCB (Printed Circuit Board). The ceramic body 1 is made of microwave dielectric material with the dielectric constant equal to or greater than 20 to effectively reduce the length of radiation metallic electrodes. The metallic ring 2 is printed on the cylindrical surface of the ceramic body 1, and the height difference of the metallic ring 2 on the ceramic body 1 forms spiral radiation metallic electrodes 21, 22, 23, and 24 with various lengths, causing 90 degrees of phase difference between the neighboring spiral radiation metallic electrodes. The length of radiation metallic electrodes 21 and 24 is less than that of the other two radiation metallic electrodes 22, and 23, and its difference is equal to /4 of operating frequency. With this design, two mutually perpendicular polarized electromagnetic fields are formed to create CPW (Circular Polarized Wave), in order to facilitate the reception of GPS satellite signal.

According to the present invention, the dielectric constant of the ceramic ground plane (or PCB) 3 is greater than 5, and a BALUN (Balanced-Unbalanced) and transformer component or circuitry 31 is embedded into the ground plane to transfer unbalanced signal to balanced signal and provide impedance matching. With this design, not too many near-field values will be created, and noise surrounding the antenna can be isolated, thereby allowing antennae with various functions to be coexisted in a tiny space without interfering with one another. This feature is especially important for hand-held electronic devices with diversely integrated functions and emphasizing compact size. Moreover, the present invention does not require grounding as a conventional antenna, hence client-side developers can save a lot of time in designing their products.

Referring to FIG. 2, a BALUN and transformer component 31 is configured on the ceramic ground plane 3 to transfer signal from unbalanced system to balanced system. Moreover, a through-hole technique is employed to drill through a vertical hole connecting the two terminals 311 of the circuitry 31 on the ceramic ground plane 3 (or PCB), and connect to the circuitry 11 of the cylindrical ceramic body 1 to touch with the metallic ring 2, thereby effectively reducing the volume of antenna body and transferring unbalanced signal to balanced signal.

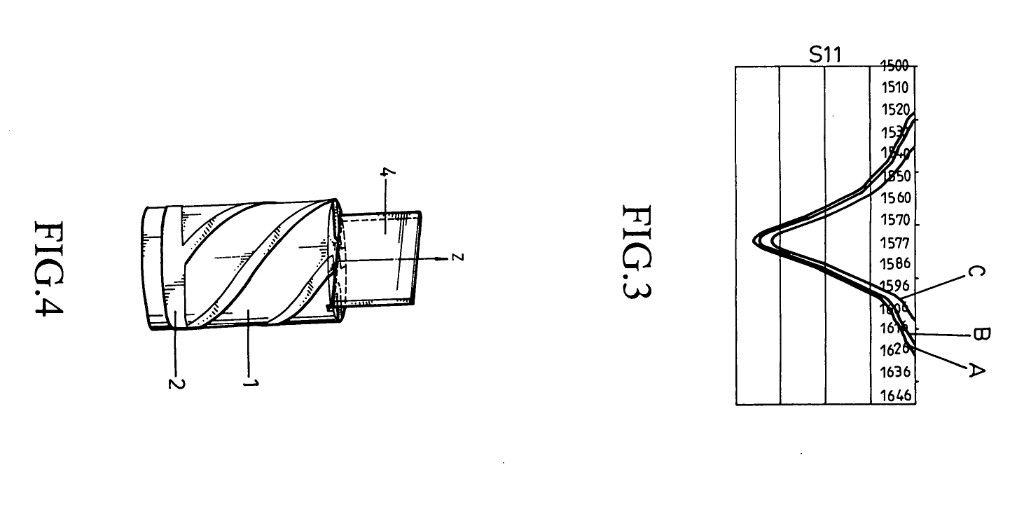

Referring to FIG. 3, it shows the influence of the antenna for various loading status for S11 of the present invention, in which curve A is for the condition of no-loading, curve B is for the condition including a rotation platform, and curve C is for the condition including hands and a rotation platform.

Referring to FIG. 4, a ceramic ground plane (or PCB) 4 can also be vertically inserted into a ceramic body 1 to combine with the cylindrical ceramic body 1.

According to the present invention, a GPS antenna comprises a body made of microwave ceramic material, and spiral radiation metallic electrodes to form a rotation loop structure that can reduce induction noise and serve as a better wave filter, and with right circular polarized all direction radiation pattern. This GPS antenna has a complete 360 degrees of reception capability, and thereby when integrating with PDA, cellular phones, or GPS hand-held devices, signal can be received independent of their positions; whereas a conventional antenna requires horizontal position to be able to receive signal.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A spiral cylindrical ceramic circular polarized antenna, including:
a ceramic body made of microwave dielectric material with the dielectric constant equal to or greater than 20;
a metallic ring printed on the cylindrical surface of the ceramic body, with its length difference on the ceramic body forming circular polarized with the different of their lengths is about λ/4 at operating frequency;
a ceramic ground plane, into which a BALUN and transformer component or circuitry is embedded, for transferring unbalanced signal to balanced signal and providing impedance matching; and on which a vertical hole is drilled through with a through-hole technique to connect two terminals of the circuitry, and connect to the circuitry of the cylindrical ceramic body to touch with the metallic ring.

2. The spiral cylindrical ceramic circular polarized antenna according to claim 1, wherein the ceramic ground plane can also be vertically inserted into the ceramic body.

3. The spiral cylindrical ceramic circular polarized antenna according to claim 1, wherein the phase difference between the neighboring spiral radiation metallic electrodes is 90 degrees.

4. The spiral cylindrical ceramic circular polarized antenna according to claim 1, wherein the length of the neighboring spiral radiation metallic electrodes is less than that of the other two radiation metallic electrodes.

5. The spiral cylindrical ceramic circular polarized antenna according to claim 1, wherein the dielectric constant of the ceramic ground plane is greater than 5.

6. The spiral cylindrical ceramic circular polarized antenna according to claim 1, wherein PCB can be used to replace the ceramic ground plane.
